(19) United States
(12) Patent Application Publication
(10) Pub. No.: US 2014/0066537 A1
(43) Pub. Date: Mar. 6, 2014

(54) ORGANIC COMPOSITIONS FOR REPEATEDLY ADJUSTABLE OPTICAL ELEMENTS AND SUCH ELEMENTS

(71) Applicants: Christine Jerome, Ougree (BE); Rachid Jellali, Liege (BE); Michaël Alexandre, Ougree (BE)

(72) Inventors: Christine Jerome, Ougree (BE); Rachid Jellali, Liege (BE); Michaël Alexandre, Ougree (BE)

(73) Assignee: Universite De Liege, Angleur (BE)

(21) Appl. No.: 13/605,058

(22) Filed: Sep. 6, 2012

(51) Int. Cl. C08F 2/46; C08G 77/04

(52) U.S. Cl. 522/4; 526/268

(57) ABSTRACT

The present invention relates an organic liquid composition comprising a mixture of a first polymer with a linear polymeric chain having two photoactive groups as endgroup; and a second polymer with a multifunctional polymeric chain having at least three photoactive groups, that can reversibly and repeatedly crosslink to form a solid polymer network wherein said liquid composition been crosslinked by irradiation with at least one wavelength L1 and been uncrosslinked at least locally by irradiating the network with at least one other wavelength L2 in order to repeatedly adjust shape and optical properties of said composition in its crosslinked state. The composition is applicable as a starting material for intraocular lenses and for other lenses and optical elements.

### FIELD OF THE INVENTION

The present invention relates to organic compositions for repeatedly adjustable optical elements and the elements containing organic compositions as well as their applications, in particular in intraocular lenses.

### BACKGROUND OF THE INVENTION

Intraocular lenses (IOLs) are intended for the replacement of the opacified human lens during a cataract surgery. The usual treatment of cataract is to surgically remove the cloudy lens by an ultrasonic method (phaco-emulsification) and to implant an artificial synthetic IOL.

One of the problems with conventional cataract surgeries relates to the fact that, prior to the surgery, it is virtually impossible to pre-select the lens to be implanted in a way that can avoid further post-invasive vision corrections. Indeed, the IOL can be removed only by another surgical intervention, which carries associated risks. In addition, the ability to view objects at both near and far distances is often altered with ageing. This causes another problem because the conventional IOLdoes not allow repeated adjustments.

Multi-focal IOLs have also been developed, working much like bifocal or trifocal eyeglasses. Patients with multi-focal IOLs usually do not get multi-focal lens after operations because of optical secondary phenomenon (halos etc.) and/or insufficient brain plasticity. Again in that case, the only way to solve this inconvenience is to exchange lens by another surgical intervention, which carries its associated risks.

The IOLs which can be adjusted after operations in a very limited way by photochemical means have been proposed in U.S. Patent Application Publication No. 2007/0035698. A semi-finished lens is implanted by the standard procedure and further shaped in situ by laser-assisted photoirradiation to modify i.e. the refractive power. Such lens material can consist of a crosslinked polydimethylsiloxane (PDMS) network swollen by polymer precursors (monomers or macro-monomers) that later on, once introduced in the eye, can only be further polymerized irreversibly. However, this material suffers from some important drawbacks.

First, the polymer precursors are based on vinyl or acrylic groups that are quite reactive and likely to cause side reactions. This may induce toxicity to these products before final polymerization. In addition, they are quite sensitive and can be altered by sunlight exposure of the patient in an uncontrollable manner. Therefore, the patient must wear dark or black sun spectacles for some time after surgery, i.e. the time required for mechanical stabilisation of the IOL in the eye, to avoid uncontrolled polymerization.

Second, a small organic molecule playing the role of photosensitizer has to be added to the lens formulation which is required for the final crosslinking process. However, it is not covalently linked to the lens material. The small organic molecule photosensitizer may diffuse and be toxic for the eye.

Finally, the photopolymerization process is irreversible. This means that the optical properties of the lens can be adjusted only once after implantation.

Polymethylmethacrylates comprising coumarin pendant units are known from U.S. Pat. No. 6,887,269. They are prepared by photochemical polymerization with vinyl functionalized coumarin derivatives. Polymethylmethacrylates can be cleaved irreversibly to release a pharmaceutical active substance.

It is also known from U.S. Patent Application Publication No. 2009/0157178 the use of a poly(7-methacryloyloxy coumarin) as a lens material wherein the coumarin group is used for its photoreversible dimerization and is covalently bonded to the polymeric chains as side chains. Photoirradiation of the coumarin at one wavelength may provide opening or closing of both adjacent polymer chains, like a zip. But the resulting product may stay in an open configuration and the number of coumarin groups that are open may be different after irradiation which may introduce certain toxicity.

Further, U.S. Pat. No. 6,423,818 discloses a coumarin ester end-capped polymer. The coumarin groups are used for the formation of a polymer network by photoreversible dimerization. However, it comprises a polymer from at least one lactone, a family of polymer which is known to be biodegradable and will not have a long-term stability.

Other documents, such as Germany Patent No. DE102007059470 or DE 2008038390 or PCT Patent Application Publication WO2009/074520, disclose ophtalmological compositions from acrylates and methacrylates which contain coumarin photoactive groups. The coumarin groups are only used as UV-absorbers and, when they dimerize, they lose their absorption activity.

Finally, U.S. Patent Application Publication No. 2009/287306 discloses an acrylic polymer with a diacrylate crosslinker and a coumarin as chromophore. Here, the coumarin only acts as photosensitizer to facilitate the crosslinking and the formation of refractive structures. In such situation, the crosslinking components are diacrylates or dimethacrylates, which renders the crosslinking irreversible.

Therefore, there is a need for a material that would avoid or at least encounter these drawbacks, not only for IOLs but likewise for other optical elements such as prisms and lenses. It is an object of the present invention to enable and provide a repeated adjustment, also in a reversible manner of, e.g. the refractive index or dioptric power of an organic optical element by a proper irradiation treatment of such optical element.

It is also known that IOLs are implanted through a very small incision in the empty capsular bag after the opacified human lens isremoved from that bag during a cataract surgery. Actually, instead of implanting a rigid or semi-rigid lens (through a non-desired larger incision in the capsular bag), a liquid composition is injected through the small incision and photopolymerized in situ to a flexible transparent lens body. This body then properly fills up the capsular bag. However, the known liquid compositions do not allow a repeatedly adjustable and reversible change of, e.g. the refractive index, of the in situ polymerized and so implanted lens after the implantation.

It is a further object of the present invention to design a liquid composition that is reversibly photocrosslinkable (in situ or not) to a cohesive, transparent and flexible material and a product or an element that at the same time or later on allows for a repeatedly adjustable and reversible change of some optical characteristics of the crosslinked material, in particular, by an appropriate irradiation treatment, which modifies the shape of the material and thus adjusts the diopter.

It is another object of the present invention to provide a conventional crosslinked material of any desired and predetermined shape and swell it in the liquid composition of the present invention so as to induce a reversibly adjustable shape and thus diopter.

With respect to a further object of the present invention, namely its particular application to IOLs, also multi-focal IOLs, the present invention aims at the realization of an exactly adjustable IOL to the required visual acuity upon implantation and capable of repeated adjustment in vivo after implantation when needed and without invasive surgicaltreatment, even years after its implantation.

For other optical elements, the present invention provides tailor-made optical properties through repeated appropriate irradiation treatments on the material or element. It is thus also an object of the present invention to produce transparent optical elements starting from the suitable photocrosslinked compositions and capable of repeated adjustment of their optical properties afterwards through further suitable irradiation treatments.

### SUMMARY OF THE INVENTION

The objects of the present invention are surprisingly achieved by an organic composition. The present invention thus provides, for the first time, a liquid composition that can be reversibly turned to a solid by light irradiation without need of varying the temperature. The liquid composition comprises polymers with polymeric chains bearing some photoactive groups able to be reversibly coupled by light irradiation at a specific wavelength L1 (leading to the crosslinking of the polymeric chains) and reversibly photocleaved when irradiated at another specific wavelength L2, the photoactive groups being capable in this way to form a photoreversible polymer network. The shape of such photosensitive network can thus be repeatedly and reversibly adjusted by (i) local irradiation of the composition with electromagnetic waves at the wavelength L2 leading to a partial cleaving (ii) by osmotic diffusion of the formed liquid free chains to the non-cleaved region of the network and (iii) by fixing the final new desired shape by stopping the diffusion by irradiating the whole material with a wavelength L1 that restores complete crosslinking.

The liquid composition can be irradiated in situ in a receptacle or mold. The receptacle can have at least one flexible wall, e.g. as in the capsular bag for an eye lens. The different wavelengths L1 and L2 are preferably chosen in the spectrum of the visible light, the near infrared or the near UV spectrum. The local irradiation can be a laser-assisted irradiation.

The term “liquid composition” here means a composition that is flowable at a temperature when it is initially placed in a mold or receptacle. For application of the present invention in vivo in IOLs, the composition should thus be liquid (i.e. pourable or injectable) in the range of 30° C. up to 40° C., particularly in the range of 35 to 40° C.

The crosslinking reaction that builds up the network is a photodimerization reaction. The photoactive groups are included in the composition as chain ends functionalities of a difunctional linear polymeric chain and/or as pendant groups along the main chain of a multifunctional polymeric chain having three or more photoactive groups per polymeric chain. The composition can be hydrophilic or hydrophobic. The composition can also be injected in a pre-existing polymeric network, said pre-existing polymeric network being swollen by the liquid composition.

### DETAILED DESCRIPTION OF THE INVENTION

The liquid composition as used in the present invention is a composition of a mixture of a first polymer with difunctional linear polymeric chains and a second polymer with multifunctional polymeric chains, also called liquid precursors.

A difunctional linear polymeric chain means a linear polymeric chain having two photoactive groups as chain ends. A multifunctional polymeric chain means either a star-shaped polymer having at least three branches of equivalent length having a photoactive group at each end of each branch, or a polymer having at least three photoactive groups as pendant groups along a main chain, optionally with one or more photoactive group as chain ends. Preferably, the multifunctional polymeric chain is star-shaped with three branches or has at least three photoactive groups as pendant groups. More preferably, the multifunctional polymeric chain has at least three photoactive groups as pendant groups. The multifunctional polymeric chain may be a block copolymer, with at least one block bearing three or more photoactive pendant groups. The difunctional and multifunctional polymeric chain are of the same chemical nature or are perfectly miscible. The same chemical nature means they are obtained from the same monomer. The ratio of difunctional linear polymeric chains and multifunctional polymeric chains may be ranged from 20%/80% to 50%/50% where % represents the weight percentage.

The polymer with the polymeric chain has a glass transition temperature lower than 40° C. It is not semi-crystalline below 40° C. and is substantially transparent at the wavelength of irradiation. Examples of suitable polymers are polyethylene glycols, polypropylene glycols, poly(ethylene-co-propylene) glycols, polyacrylates, polysiloxanes, polydimethylsiloxanes or other polymers that are liquid according to above definition. In case of polydimethylsiloxanes, preferred molecular weight for difunctional polymeric chain is in the range 1000-30000 g/mol, most preferred in the range 1000-3000 g/mol; and preferred molecular weight for multifunctional polymeric chain is in the range 3000-30000 g/mol, most preferred in the range 3000-8000 g/mol.

The photoactive groups of the difunctional linear polymeric chain and of the multifunctional polymeric chains are preferably the same and are any group that is able to undergo a reversible photodimerization. Preferably, they undergo a 2+2 cyclo-addition to form a cyclobutane ring upon photodimerization. Examples of groups allowing for this reaction are coumarin, thymine, anthracene, cinnamic acid group, cinnamates. The preferred number of photoactive groups per chain in the multifunctional polymeric chain is between 3 and 20. Most preferred is a ratio between the number of photoactive group in the multifunctional polymeric chain and the molecular weight of the multifunctional polymeric chain in the range 1/1000-1/2000.

The photoactive liquid precursors can be used as an injectable liquid composition that can be crosslinked by photoirradiation or can be inserted in a pre-existing network upon swelling. In one preferred embodiment, the photoactive liquid precursors or organic liquid composition is introduced or injected in a mold or receptacle. The mold may have at least one flexible wall, e.g. as in a capsular bag for an eye lens.

When introduced or injected in a mold, the liquid composition is crosslinked by light irradiation and becomes a solid network at the working temperature, advantageously, without requiring changing temperature. The solid network is transparent at the wavelength of irradiation. Moreover, it may be transparent at the visible wavelengths such as when using polysiloxanes with coumarine photoactive group. This is particularly advantageous for intraocular lens.

Light irradiation may be performed with a light source, such as a laser, at a specific wavelength L1 and the solid network may be, for example, an optical element, particularly a lens.

The solid network obtained by irradiation can then be reversibly photocleaved when irradiated locally with the light source at another specific wavelength L2; allowing for a diffusion of formed liquid free chains to the non-cleaved or non-irradiated regions. Such diffusion of the free chains will induce a modification of the shape of the mold, such as, for example, a modification of the shape of an intraocular lens.

By using local laser irradiation, the photocleavage or uncrosslinking can be induced only in a desired portion of the optical element, in particular, a lens, leading then to a difference in the mobility (osmotic diffusion) between the crosslinked and uncrosslinked regions. This causes the diffusion of uncrosslinked liquid chains within the element, towards the crosslinked (non-irradiated) regions. If the lens or other optical element possesses sufficient elasticity, this diffusion can swell the element in the non-irradiated region which changes the shape of the lens and consequently its optical properties.

A dioptre modification of the optical element by local laser irradiation at a L2 wavelength can lead to partial rupture (or cleavage) of the network. This is then followed by osmotic diffusion of the liquid molecule and further by irradiation at wavelength L1 to induce e.g. complete crosslinking resulting in solidification and fixation of the novel shape of the element.

The shape of such photoactive network may thus be repeatedly and reversibly adjusted in a process comprising the following steps:
i) crosslinking of the organic liquid composition by an irradiation with an electromagnetic wave at a specific wavelength L1 to obtained a crosslinked composition;
ii) at least a partial uncrosslinking by irradiation at wavelength L2 of the crosslinked composition to obtained free liquid chains;
iii) osmotic diffusion of the free liquid chains to the still fully crosslinked regions, inducing a shape modification through swelling;
iv) fixing of a modified shape by stopping the migration of the free liquid chains by irradiation at wavelength L1.

The reversible crosslinking is preferably insured by a reversible photodimerization reaction by 2+2 cycloaddition to form a cyclobutane ring. The examples of groups allowing this reaction are coumarin, thymine, anthracene, cinnamic acid groups, cinnamates, or others resulting in cyclobutanes upon photodimerization. These groups are covalently attached to the two chain ends of difunctional polymers, or to the chain ends of multifunctional (star shaped) polymers and/or as pendant group along the main chain of polymers or oligomers. These photoactive polymers can be used in mixtures so that a network is formed upon irradiation. They can also be introduced in a pre-existing or preformed polymeric network.

Illustrative examples of a suitable pre-existing or preformed polymeric network include polyacrylates, poly(meth)acrylates e.g. poly(methyl methacrylate) (PMMA), poly(2-hydroxyethyl methacrylate) (PHEMA) and hydroxypropyl methacrylate (HPMA); polyvinyls and polyvinylpyrrolidone (PNVP), polyphosphazenes, polysiloxanes and polyurethanes and copolymers thereof. This preformed network has the ability to be swollen by the photoactive liquid composition to allow liquid chains diffusion within the network. It is typically formed by irreversible covalent crosslinking of a polymer of similar nature as the chains of the photoactive composition. Hydrogel networks such as polyethylene glycols (PEG), polyurethanes based networks and hydrophobic networks such as polyurethanes or polydimethylsiloxane (PDMS) based networks are preferred.

Hydrophilic compositions based on a mixture of linear and star chains of polyethylene glycols (PEG) end-capped with coumarin or hydrophobic compositions based on a mixture of linear poly(dimethylsiloxane) (PDMS) end-capped with coumarin and poly(dimethylsiloxane) (PDMS) bearing pendant coumarins are preferred.

One key aspect of the present invention lies in the choice of the chemical group performing the photoinduced crosslinking which allows the reverse reaction to occur, depending on the choice of wavelengths L1 and L2. This makes repetition of the process feasible.

The local irradiation is another important element allowing a spatial control of the uncrosslinking.

The modification of the optical properties is based on the use of novel compositions, characterized by photoreversible crosslinking reactions. Upon laser irradiation at a specific wavelength L1, the liquid precursors of the composition can be crosslinked without the help of a photoactivator. The laser irradiation of the formed network at a second well-defined wavelength L2 provokes the reverse reaction leading to the controlled rupture or cleavage of the network.

The present invention and its advantages will be better understood on reading the following description given by way of examples and with reference to the appended drawings.

### BRIEF DESCRIPTION OF THE DRAWINGS

FIG. 1 illustrates an organic liquid composition (1) undergoing a process with steps A, B, C and D in an optical element for its shape modification;

FIG. 2 illustrates an organic liquid composition (1) undergoing a process with steps A, B, C and D in an optical element for another shape modification;

FIG. 3 illustrates the percentage of transmittance as a function of the wavelength for PDMS-coumarin mixture B in Table 3;

FIG. 4 illustrates the changes of the UV spectrum absorbance of PDMS-coumarin (product 5 in Table 1), as thin film upon irradiation with a 200 W high-pressure mercury lamp (λ>300 nm) at room temperature;

FIG. 5 illustrates the dimerization reaction rate of PDMS-coumarin mixtures B and F in Table 3;

FIG. 6 illustrates the changes of the UV spectrum absorbance of PDMS-coumarin mixture B in Table 3 upon irradiation with a 200 W high-pressure mercury lamp (λ>300 nm), followed by irradiation with sterilization UV tube (40 W at 254 nm);

FIG. 7 illustrates the evolution of fluorescence intensity I_{D}/I_{F} ratio for 5 different PDMS-coumarin mixtures (A to E in Table 3);

FIG. 8 illustrates SEM images of patterns obtained after free linear PDMS-coumarin interdiffusion in a crosslinked PDMS network using a PDMS-coumarin mixture B in Table 3;

FIG. 9 illustrates high-resolution maps and thickness profile of the photopatterned PDMS thin film on a glass slide substrate recorded by profilometry using a PDMS-coumarin mixture B in Table 3;

FIG. 10 illustrates the chromatograms of linear coumarin-based PEG before irradiation (dark line), after first irradiation at λ>300 nm (grey line) and after second irradiation at λ=254 nm (dotted line) (intensity in arbitrary units as a function of time in minutes);

FIG. 11 illustrates a synthetic route of 7-chlorocarbonylmethoxy-4-methylchromen-2-one;

FIG. 12 illustrates the synthesis of difunctional and multifunctional coumarin-based PDMS;

FIG. 13 illustrates the synthesis of linear coumarin-functionalized polyethylene glycol; and

FIG. 14 illustrates the synthesis of coumarin-functionalized star polyethylene glycol.

### EXAMPLES

### Example 1

### Liquid Composition According to the Present Invention as an Optical Element, Particularly an Intraocular Lens and its Shape Modification

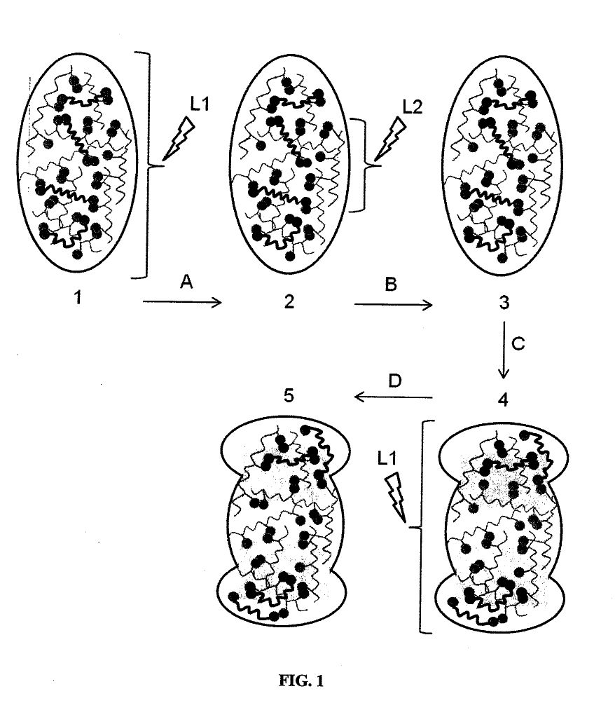

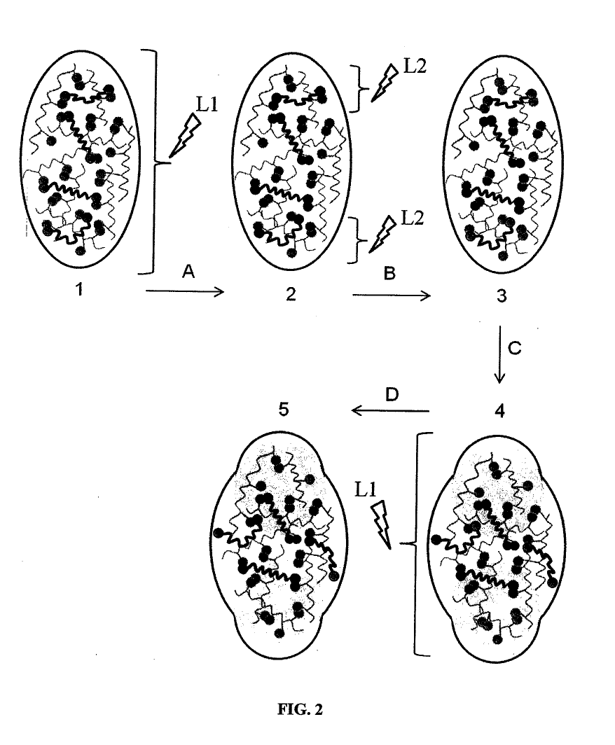

The organic liquid composition (1) of FIG. 1 comprises a mixture of a first polymer with a difunctional linear polymeric chain (represented by black wave) and a second polymer with a multifunctional polymeric chain (represented by grey wave). The difunctional linear and multifunctional polymeric chains have photoactive groups covalently attached to said polymeric chains. The photoactive groups are present as an end group of the difunctional linear polymeric chain and as a pendant group of the multifunctional polymer chain. In such organic liquid composition, (1) the photoactive groups are in an open configuration (represented by grey balls) which means that they have not dimerized. For example, the photoactive groups are coumarin groups. In the organic liquid composition (1), the photoactive groups may be attached to the polymeric chain by any functional group allowing a covalent bond. A linker may also be present between the photoactive group and the polymeric chain such as linear alkyl chains comprising typically 2 to 6 CH2 groups and more typically 2 to 4 CH2 groups.

The process of modification of the shape and hence the optical properties of the organic liquid composition (1) comprises a step A of crosslinking the organic liquid composition (1) by an irradiation with an electromagnetic wave at a specific wavelength L1 (for example >300 nm in case of coumarin) to obtained a crosslinked composition (2). The crosslinking step A forms crosslinking nodes between difunctional polymeric chains and multifunctional polymeric chains and among the multifunctional polymeric chains. The crosslinking step A occurs in a short period of time, e.g. in less than 3 hours, preferably in less than 2 hours, more preferably in less than 1 hour, even more preferably in less than 10 minutes. For example, the crosslinking occurs in 60 minutes. The crosslinking step A occurs without the help of a photoactivator. In the crosslinked composition (2), the photoactive groups have undergone a photodimerization reaction and are thus in dimerized form (represented as black balls).

The process of shape modification further comprises a step B of local uncrosslinking of the crosslinked composition (2) by a local irradiation with an electromagnetic wave at a specific wavelength L2 (such as, 254 nm, or a double wavelength 510 nm with a double photon absorption technique in case of coumarin) to obtain a partially uncrosslinked composition (3). The wavelength L1 and L2 are different and are preferably chosen in the spectrum of the visible light, the near infrared or the near UV spectrum. For the coumarin groups, they are in the near UV spectrum or in the visible spectrum. For the IOL application, a non-toxic wavelength for the eye will be chosen.

The local uncrosslinking step B allows a cleavage or rupture of at least some crosslinking nodes by reverse photodimerization reaction. Advantageously, in local uncrosslinking step B at least some chains are completely cleaved forming free polymeric chains. By completely cleaved, one means that each dimerized photoactive group on a chain is cleaved and has recovered its original form. The partially uncrosslinked composition (3) comprises at least some free polymeric chains. Statistically, most of the free polymeric chains are linear difunctional polymeric chains and are flowable, which means they are mobile and can diffuse through the composition at a working temperature. Advantageously, the local irradiation allows a difference of mobility between the crosslinked and the uncrosslinked parts of the composition (3). Although the partially uncrosslinked composition (3) comprises liquid chains, its consistency is maintained thanks to the multifunctional polymeric chains that form a network. Advantageously, such network is not completely cleaved by the local uncrosslinking step B. Preferably, the partially uncrosslinked composition (3) is a gel and does not flow at the working temperature (in case of intraocular lens the working temperature will be between 35 and 40° C.).

In FIG. 1, the local irradiation is done by laser and the local uncrosslinking step B is performed in the center of the mold comprising the crosslinked composition (2). In FIG. 2, local irradiation is performed at the edges of the mold comprising the crosslinked composition. The local uncrosslinking step B occurs in a reasonable period of time, in less than 48 hours, preferably in less than 12 hours, more preferably in less than 1 hour, even more preferably in less than 10 minutes.

The process further comprises a step C of diffusion of at least some of the free polymeric chain obtained in step B resulting in a composition with a modified shape (4). In the diffusion step C, the free linear polymeric chains migrate by osmotic diffusion. Preferably, in the diffusion step C, the free polymeric chains diffuse towards crosslinked regions. Preferably, the diffusion step C causes a swelling of the crosslinked regions (3) which changes the shape and consequently the optical properties. The diffusion step C can be carried out at a temperature in the range of 35-40° C. The preferred temperature is 37° C. in intraocular lens application. Advantageously, the diffusion step C occurs in a short period of time, less than 48 hours, preferably less than 24 hours, even more preferably less than 12 hours.

The process further comprises a step D of crosslinking the whole composition with modified shape (4) by the irradiation of step A to obtain a stable crosslinked composition with modified shape (5).

### Example 2

### Synthesis of Coumarin-Functionalized Polydimethylsiloxanes

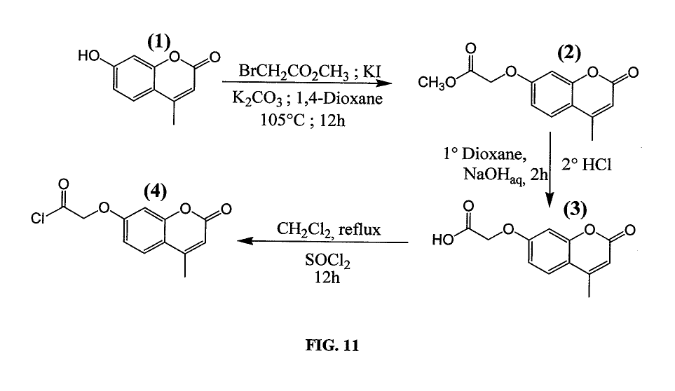

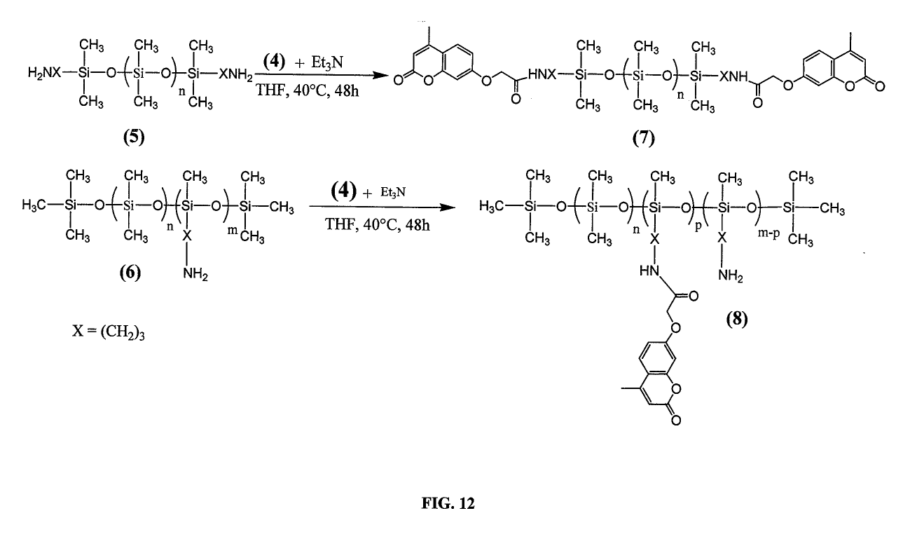

The photoactive hydrophobic compositions based on coumarin-functionalized polydimethylsiloxanes (PDMS) were obtained by reaction of coumarin acid chloride on α, ω dihydroxy or α, ω diamine linear PDMS and linear aminopropylmethylsiloxane-co-dimethylsiloxane copolymers (FIGS. 11 and 12).

Among the used materials, 4-methylumbelliferone (C₁₀H₈O₃), methyl bromoacetate (C₃H₅BrO₂), thionyl chloride (SOCl₂) and potassium carbonate (K₂CO₃, 99%) were purchased from Aldrich and used without previous purification. Triethylamine (Aldrich, 99%) was dried over calcium hydride under stirring at room temperature for 24 hours and distilled under reduced pressure before use. Aminopropylmethylsiloxane-dimethylsiloxane copolymer (molecular weight: 4000-5000 and 7000-9000 g/mol) and aminopropyl terminated polydimethylsiloxane (molecular weight: 900-1000, 3000 and 30000 g/mol) were purchased from ABCR. Toluene, tetrahydrofuran (THF) and dichloromethane were dried on a MBraun SPS800 Solvent Purification system. Other solvents (1,4-dioxane; Merck and ethanol; Chem-Lab) and reagents (potassium iodide; VWR, sodium hydroxide; Acros and hydrochloric Acid; merck) were used as received.

### 2a) Synthesis of Coumarin Acid Chloride Derivative 7-chlorocarbonylmethoxy-4-methylchromen-2-one

FIG. 11 summarizes the synthetic route of coumarin acid chloride derivative 7-chlorocarbonylmethoxy-4-methylchromen-2-one (product (4) in FIG. 11). To a solution of 4-methylumbelliferone (15.00 g) in 1,4-dioxane (150 mL), potassium carbonate (23.4 g, 2.0 eq.), potassium iodide (150 mg) and methyl 2-bromoacetate (8.1 mL, 1.0 eq) were added. The mixture was heated to 105° C. for 14 hours and then hydrolyzed at room temperature for 2 hours in a 200 mL of NaOH aqueous solution (1M). After acidification of the solution with hydrochloric acid (37%), the resulting mixture was extracted 3 times with dichloromethane. The combined organic phases (product (3) in FIG. 11) were dried over MgSO₄, concentrated under reduced pressure and recrystallized from ethanol with an isolated yield of 87%. ¹H NMR (250 MHz, d-CDCl₃/d₆-DMSO), δ ppm: 7.49 (d, 1H, ArH), 6.85 (m, 1H, ArH), 6.73 (d, 1H, ArH), 6.05 (d, 1H, H-pyrone ring), 4.61 (s, 2H, —OCH₂CO), 2.34 (d, 3H, CH₃-pyrone ring).

7-Carboxymethoxy-4-methylchromen-2-one (product (3) in FIG. 11) was refluxed with thionyl chloride (3.2 eq) and dichloromethane. After 12 hours, the reaction mixture was diluted in 100 mL of heptane and the dichloromethane was evaporated under a reduced pressure until the precipitation started. The mixture was left to stand at 0° C. for 30 minutes and the solid 7-chlorocarbonylmethoxy-4-methylchromen-2-one (product (4) in FIG. 11) was collected by filtration. The yield was 96%, ¹H NMR (d-CDCl₃, 250 MHz), δ ppm: 7.54 (d, 1H, ArH), 6.87 (m, 1H, ArH), 6.78 (d, ArH), 6.18 (d, 1H, H-pyrone ring), 5.02 (s, 2H, —OCH₂CO), 2.40 (d, 3H, CH₃-pyrone ring).

### 2b) Synthesis of Difunctional and Multifunctional Coumarin-Based PDMS

FIG. 12 summarizes the synthetic routes of difunctional and multifunctional coumarin-based PDMS. Coumarin-functionalized polydimethylsiloxanes (coumarin-based PDMS) were obtained by the reaction of the coumarin acid chloride derivative 7-chlorocarbonylmethoxy-4-methylchromen-2-one (product (4) in FIG. 11) on α, ω diamine linear PDMS (product (5) in FIG. 12) and linear aminopropylmethylsiloxane-co-dimethylsiloxane copolymers (product (6) in FIG. 12).

Typically, α, ω diamine linear PDMS (product (5) in FIG. 12), dried by three azeotropic distillations with toluene, was dissolved in 50 mL distilled tetrahydrofuran (THF) then combined with distilled triethylamine (1.1 equivalent per NH₂ functions) and stirred under nitrogen atmosphere. 7-Chlorocarbonylethoxycoumarin (1.1 eq/NH₂ functions) dissolved in 20 mL distilled THF was added dropwise to the mixture of α, ω diamine linear PDMS (product (5) in FIG. 12) and triethylamine. After 48 hours at 40° C., THF was evaporated and the recovered product dissolved in dichloromethane. The solution was then washed three times with a NaHCO₃ saturated solution. The organic phase was dried over MgSO₄ and evaporated under a reduced pressure. Difunctional coumarin-based PDMS (product (7) in FIG. 12) was obtained. The same procedure was followed for the functionalization of linear aminopropylmethylsiloxane-co-dimethylsiloxane copolymers (product (6) in FIG. 12) to obtain multifunctional coumarin-based PDMS (product (8) in FIG. 12). The chemical structures of the two functionalized photosensitive PDMS were confirmed by ¹H NMR (d-CDCl₃, 400 MHz).

TABLE 1

| | Polymer code | Mn (g/mol) | f | Coumarin groups |
|---|---|---|---|---|
| 1 | PDMS 1K-2C | 1000 | 2 | chain-end |
| 2 | PDMS 3K-2C | 3000 | 2 | chain-end |
| 3 | PDMS 30K-2C | 30000 | 2 | chain-end |
| 4 | PDMS 4K-3C | 4000 | 3 | along the chain |
| 5 | PDMS 8K-4C | 8000 | 4 | along the chain |
| 6 | PDMS 8K-6C | 8000 | 6 | along the chain |

f = functionality in coumarin

The polymer codes detailed in Table 1 are used in the examples below and in the Figures. The proportion of the mixture of the different coumarin-based PDMS will be expressed in “%” where “%” represents the weight percent.

### Example 3

### Photoreversible Reaction of Coumarin-Based PDMS

### 3a) Crosslinking Step

Coumarin end-capped PDMS (product (7) in FIG. 12 and with polymer code of Table 1 (PDMS 3K-2C) and PDMS bearing 4 pendant coumarin (product (8) in FIG. 12 and with polymer code of Table 1 (PDMS 8K-4C) were mixed in a proportion of 70% PDMS 8K-4C and 30% PDMS 3K-2C and injected in a mold. This mixture was then crosslinked by irradiation of the mold in air at wavelength L1 (also referred to as λ₁)>300 nm (I=100 mW/cm²) at an ambient temperature. This mixture was rapidly converted from a liquid to an elastic solid, reproducing the mold shape accurately. The solubility tests in common organic solvents (such as acetone, toluene, dichloromethane, heptane, diethylether) revealed that the solid is insoluble in such solvents confirming the formation of a solid crosslinked network.

The transparency of the obtained solid network was characterized by transmittance by using a Hitachi U-3300 UV-vis spectrophotometer. The spectral transmittance is shown in FIG. 3. The polymer network has excellent optical property, and its spectral transmittance is higher than 80% in the visible wavelength region of 400-800 nm.

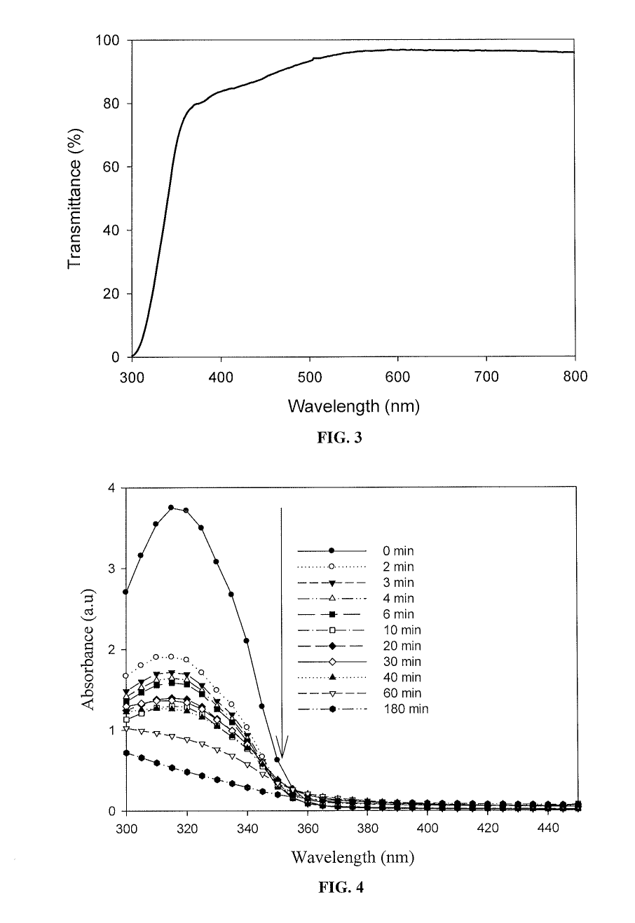

To investigate the kinetics of coumarin-based PDMS crosslinking (coumarin dimerization), UV absorbance at 320 nm was monitored (Hitachi U-3300 UV-vis spectrophotometer) in order to track the amount of unreacted coumarin groups. The photocrosslinking reaction was examined in a solid thin film, which was cast from dichloromethane solution onto a glass slide at room temperature, by irradiation with 200 W Hg/Xe arc lamp (λ>280 nm and I=100 mW/cm²). FIG. 4 shows the UV spectra of coumarin-based PDMS (PDMS 8K-4C) in dichloromethane. The λ max absorbance of PDMS-coumarin near 320 nm in the UV-Vis absorbance spectrum is typical of coumarin derivatives containing polymers. The absorption of PDMS-coumarin at this wavelength is due to the presence of coumarin chromophore moieties on PDMS and the polymer does not change the optical characteristics of coumarin groups. The coumarin absorption maximum at 320 nm decreases with irradiation time, which indicates that coumarin group underwent a photochemical reaction. The intensity decreases due to the disruption of conjugation in coumarin is proportional to the consumption of the 3,4-olefin in the coumarin derivatives. Coumarin group is well known to undergo a [2+2] photocycloaddition, resulting in the formation of a cyclobutane ring.

The influence of PDMS-coumarin structure (molecular weight and functionality in coumarin) on the photocrosslinking reaction was also studied. FIG. 5 shows the percentage of dimerized coumarin as a function of UV exposure time for two PDMS-coumarin mixtures containing two different multifunctional coumarin-based PDMS (PDMS 8K-4C and PDMS 4K-3C both mixed with PDMS 3K-2C with a proportion of 70%/30%). A great part of crosslinking (62 and 45% with PDMS 8K-4C and PDMS 4K-3C respectively) was accomplished in the first 10 minutes of irradiation and crosslinking was completed after 2 hours of irradiation. This phenomenon could be attributed to the formation of a crosslinked network which reduces the chains mobility and decreases the accessibility between the coumarin groups. Then, for high irradiation times, the lamp energy increases the temperature of material and improves the chains mobility. Accordingly, the crosslinking rates reached after 2 h of irradiation were in the order of 85%. The crosslinking kinetic of mixture based PDMS 8K-4C was faster than that of the mixture based on PDMS 4K-3C. This result may be explained as follows: in the case of the mixture based on PDMS 8K-4C, the formed network is more flexible (more chains mobility and coumarin accessibility) due to the presence of more free space between the photoactive coumarin units in the polymer chain, therefore, more space between the network links.

### 2b) Uncrosslinking Step

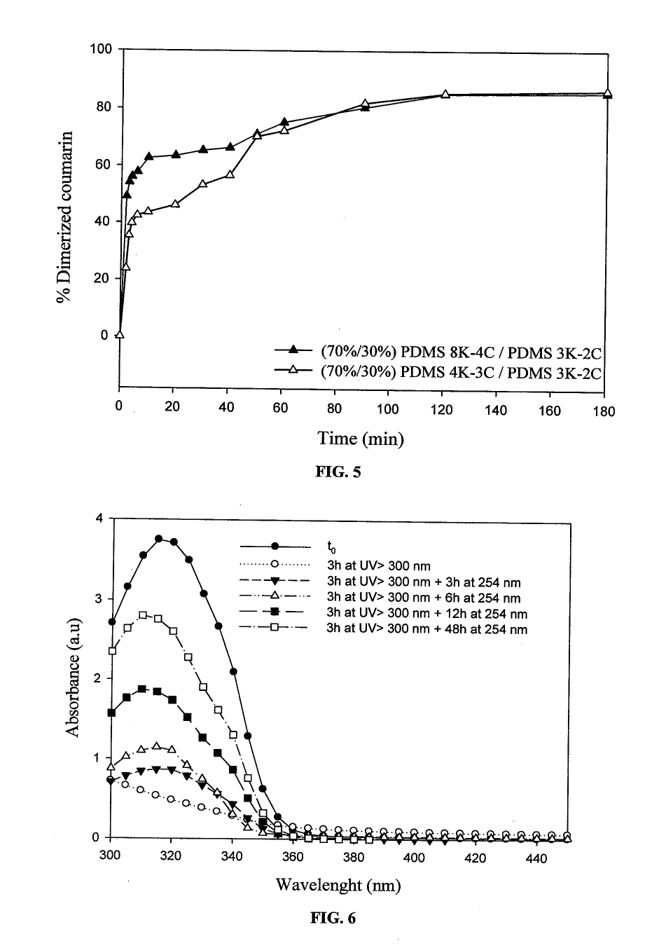

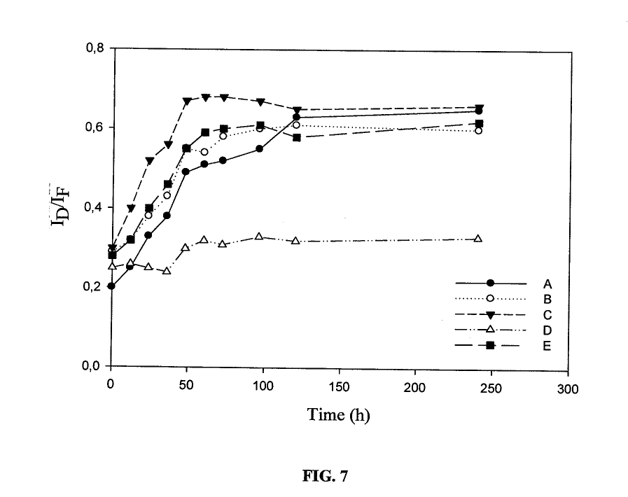

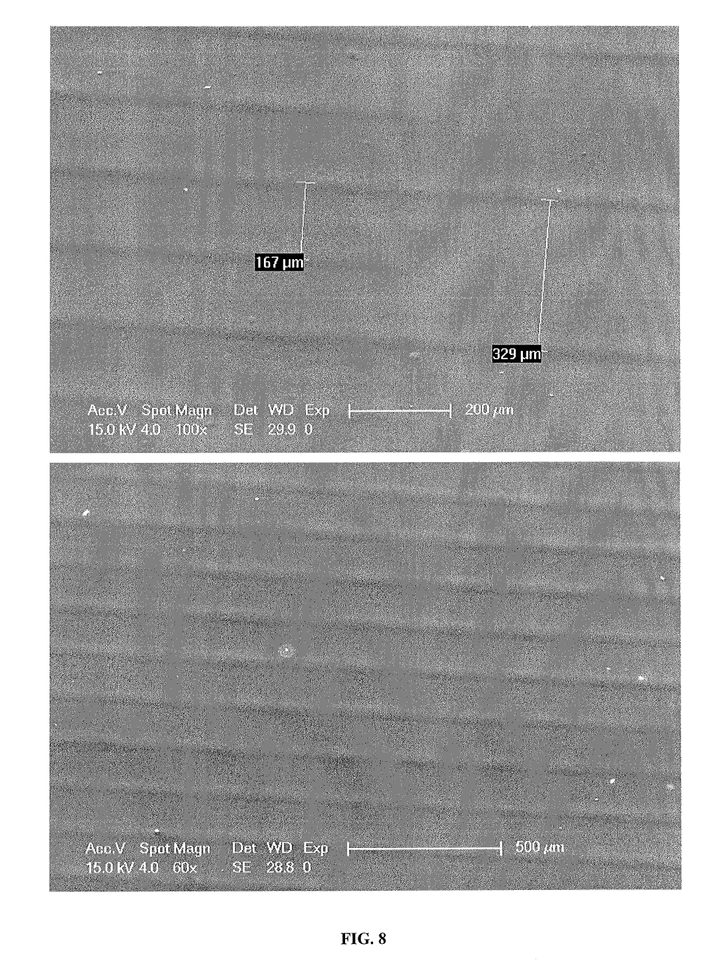

Cyclobutane rings that were formed from coumarin dimerization can undergo cleavage by UV irradiation at wavelength L2 (also referred to as λ₂)=254 nm. In order to demonstrate the crosslinking reversibility, a PDMS-coumarin mixture (PDMS 8K-4C mixed with PDMS 3K-2C) in proportion 70%/30% was injected in a mold and the mold was irradiated in air by sterilization UV tube (40 W at 254 nm) at ambient temperature. FIG. 6 shows the UV spectrum evolution after irradiation with UV light at a wavelength of 254 nm. The absorption band at 320 nm increased with increasing time of irradiation, indicating cleavage of the cyclobutane ring and a return to the initial state coumarin-monomers due to photo-cleavage of the coumarin dimers.

### Example 4

### Diffusion of Linear Difunctional Coumarin-Based PDMS in a Crosslinked Network of Coumarin-Based PDMS

Different PDMS-coumarin mixtures were prepared and were cast on glass to obtain films, as detailed above (Table 2, left column). The films were irradiated at λ₁>300 nm during 1 hour. The resulting crosslinked films were then immersed in liquid difunctional coumarin-based PDMS (Table 2, first line) at 40° C. After 24 hours, films were removed from the liquid difunctional coumarin-based PDMS and a swelling rate was calculated for each film as follows:

Swelling rate=[(Weight after swelling−Initial weight)/initial weight]*100.

The results of swelling rates (Table 2) show that the all crosslinked films swell in the presence of liquid functionalized PDMS. The swelling rate is more important for the low molecular weight liquid difunctional coumarin-based PDMS. These results confirm the possibility for linear difunctional coumarin-based PDMS to diffuse in crosslinked PDMS-coumarin networks.

TABLE 2

| | PDMS | PDMS |
|---|---|---|
| | 30K-2C | 1K-2C |
| Film A1 (100% PDMS 8K-6C) | 6% | 15% |
| Film B1 (75% PDMS 8K-6C/25% PDMS 30K-2C) | 9% | 17% |
| Film C1 (50% PDMS 8K-6C/50% PDMS 30K-2C) | 10% | 17% |

### Example 5

### Interdiffusion of Linear Difunctional Coumarin-Based PDMS in a Crosslinked Network of Difunctional and Multifunctional Coumarin-Based PDMS

The diffusion of linear difunctional coumarin-based PDMS in a crosslinked network of difunctional and multifunctional coumarin-based PDMS was studied by fluorescence microscopy (Olympus IX71 microscope). Indeed, upon excitation at 350 nm, PDMS bearing coumarin groups exhibit a strong fluorescence emission at 390 nm. After coumarin group photodimerization (irradiation at λ₁>300 nm), the crosslinked polymers are not fluorescent at this wavelength.

TABLE 3

| | |
|---|---|
| Multifunctional PDMS | Difunctional PDMS |

| | Mn (g/mol); f | % | Mn (g/mol); f | % |
|---|---|---|---|---|
| A | 8000; 4 | 50 | 3000; 2 | 50 |
| B | 8000; 4 | 70 | 3000; 2 | 30 |
| C | 8000; 4 | 70 | 1000; 2 | 30 |
| D | 8000; 4 | 70 | 30000; 2 | 30 |
| E | 4000; 3 | 70 | 1000; 2 | 30 |
| F | 4000; 3 | 70 | 3000; 2 | 30 |

f = functionality in coumarin

Different PDMS-coumarin mixtures (listed in Table 3) were cast on glass, covered by a photomask and irradiated for 2 hours at λ₁>300 nm ((I=100 mW/cm²). Fluorescence intensity of crosslinked and free zone (free PDMS-coumarin) was measured every day using fluorescence microscopy. The diffusion was evaluated at a temperature of 37° C. by monitoring of I_{D}/I_{F} ratio, were I_{D} and I_{F} are the fluorescence intensity in the dark zone (crosslinked PDMS-coumarin) and fluorescence intensity in the fluorescent zone (free PDMS-coumarin), respectively. The results are presented in FIG. 7. The increase in the (I_{D}/I_{F}) ratio confirms the presence of free linear PDMS diffusion towards the crosslinked polymers zone. It was also observed that the diffusion is more important for polymers of a low molecular weight (PDMS 1K-2C compared to PDMS 3K-2C). PDMS 30K-2C only slightly diffuses. The diffusion also depends on the amount of empty space in the network as shown by the comparison of the networks based PDMS 4K-3C and PDMS 8K-4C. In the case of PDMS 8K-4C film, the formed network is more flexible due to the presence of more free space between the network links. Consequently, the chain mobility facilitates the creation of free volume and the linear difunctional PDMS-coumarin diffusion.

### Example 6

### Interdiffusion Effect Studies by Microscopy and Profilometry

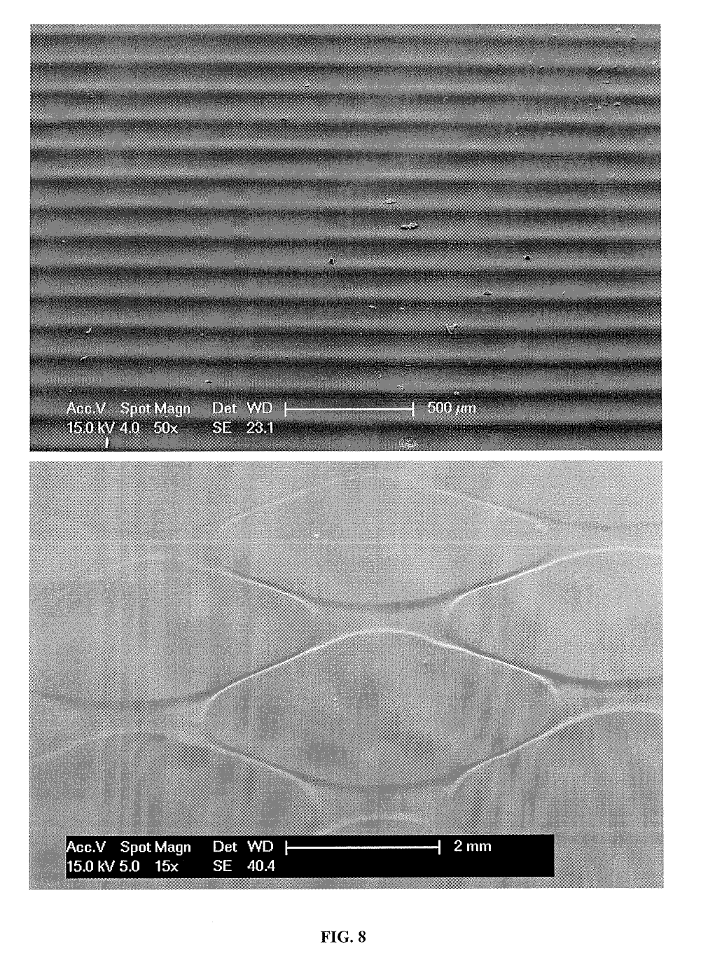

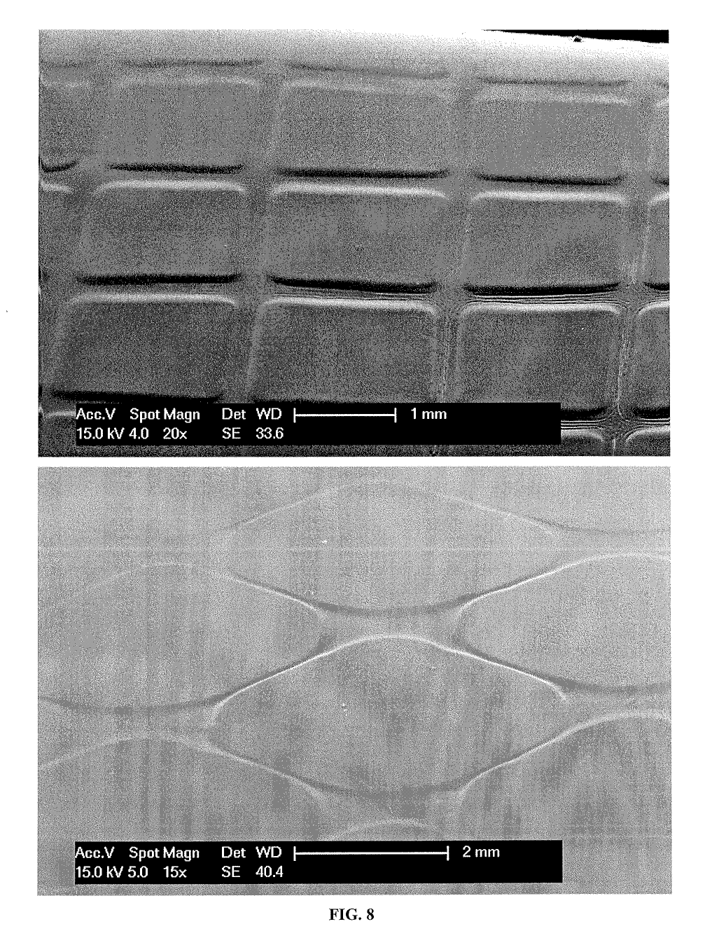

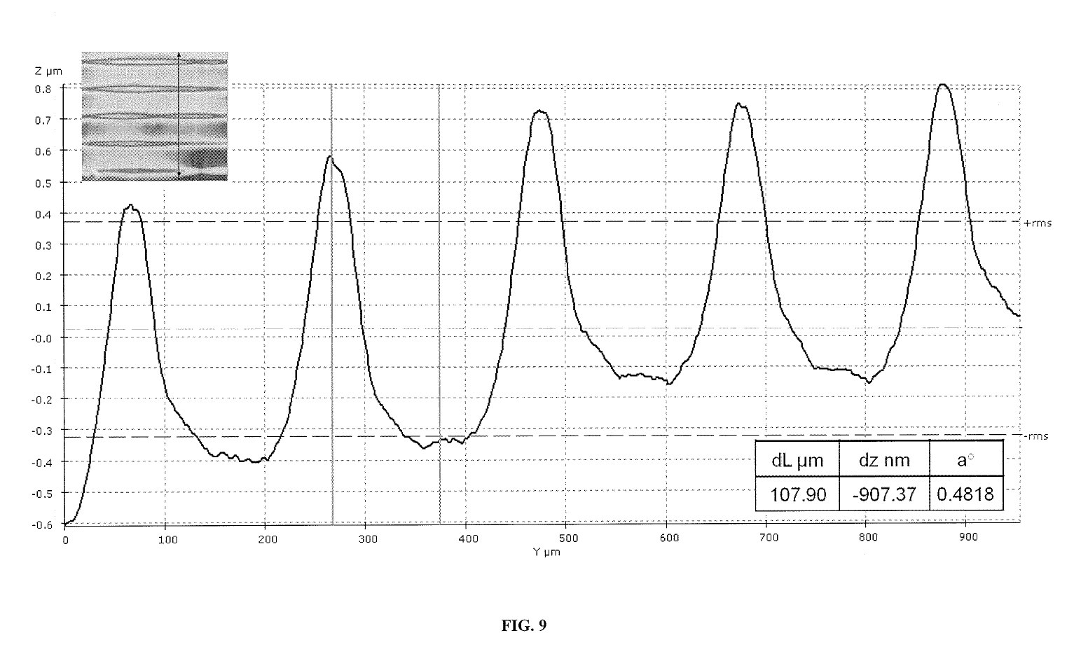

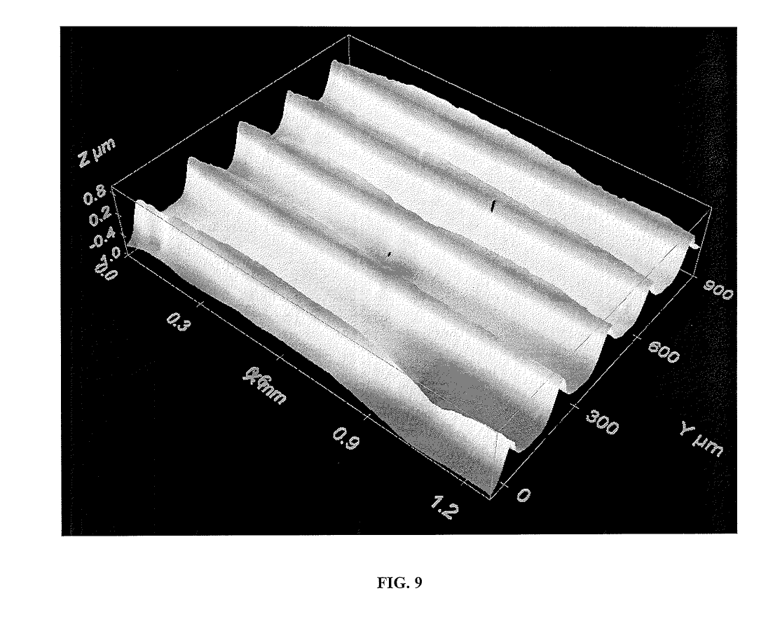

Scanning Electron Microscopy and profilometry were used to reveal the shape modification after a linear PDMS interdiffusion. Different experiments were performed by varying the photomasks and the PDMS-coumarin mixtures. The SEM images in FIG. 8 and profilometry analysis in FIG. 9 show patterns of the PDMS-coumarin mixture (70/30%; PDMS 8K-4C/PDMS 3K-2C), exposed through the photomasks at UV light (>300 nm), for 2 hours) fabricated on glass slides under the optimized diffusion conditions (a temperature of 37° C. and a duration of 48 to 72 hours), using different photomasks. A clearly identifiable photo pattern was observed on different images in particular straight lines in the upper images of FIG. 8 or squares in the lower images of FIG. 8. In agreement with the diffusion flux, the pattern lowest zone corresponds to the network part which was non-crosslinked during the first step of UV irradiation.

### Example 7

### Synthesis of Coumarin-Functionalized Polyethylene Glycol

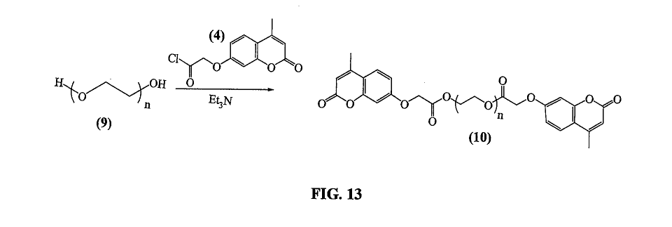

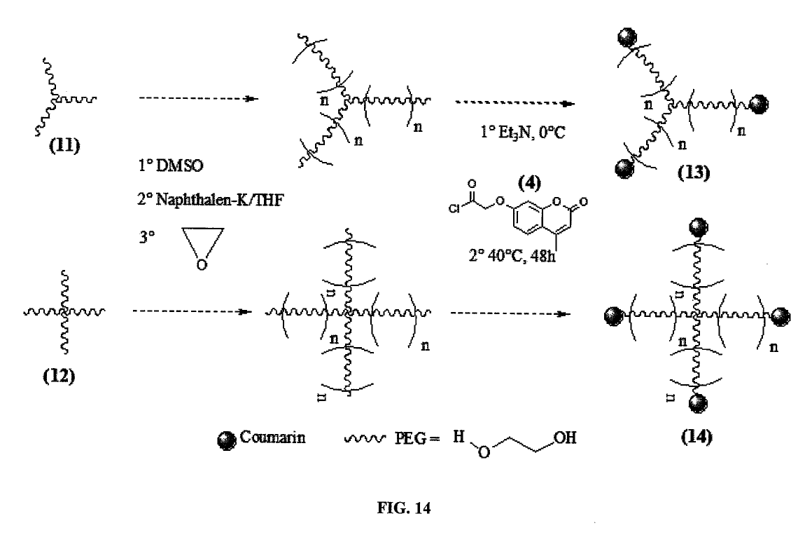

Photoreversible hydrophilic compositions based on coumarin-functionalized polyethylene glycol (photoactive PEGs, abreviated as COU-PEG-COU) were obtained by the esterification of coumarin acid chloride derivative 7-chlorocarbonylmethoxy-4-methylchromen-2-one (synthesized as described in example 1) with PEG diols of different molecular weights (commercial products from Fluka). Three-arm and four-arm star hydroxyPEGs were similarly end-capped with coumarin. The synthetic route is illustrated in FIG. 13 and FIG. 14.

Typically, PEG diol (Fluka, dried by three azeotropic distillations with toluene) was dissolved in 50 mL distilled tetrahydrofuran (THF), then mixed with triethylamine (1.1 equivalent per OH functions) and stirred 30 minutes under nitrogen atmosphere at 0° C. 7-chlorocarbonylethoxycoumarin (1.1 eq/OH functions) was dissolved in 20 mL distilled THF and added dropwise to the PEG and triethylamine mixture. After 48 hours at 40° C., THF was evaporated under a reduced pressure and the product dissolved in a NaHCO₃ saturated solution. Finally, the mixture was dialyzed to eliminate the excess of 7-chlorocarbonylethoxycoumarin and lyophilized. Linear difunctional coumarin-based PEG (product (10) in FIG. 13) was so obtained.

Three-armed coumarin-based PEG (product (13) in FIG. 14) and four-armed coumarin-based PEG (product (14) in FIG. 14) were obtained by the same procedure starting from PEG tri- and tetra-armed stars.

First, PEG tri- and tetra-armed stars were prepared by living anionic polymerization of ethylene oxide using glycerol ethoxylate (Aldrich) and pentaerythritol ethoxylate (Aldrich) as initiators. The anhydrous initiator was dissolved in dry dimethylsulfoxide (DMSO, 150 mL) under a slight nitrogen overpressure and a solution of freshly prepared naphtalen-potassium complex (concentration was adjusted to deprotonate only 10% of the hydroxyl functions) in THF was added. The initiator solution was transferred into a 1 L stainless steel reactor and a given amount of ethylene oxide was added for polymerization. After 48 hours at 30° C., the alkoxides were deactivated by adding methanol. The solution was concentrated and precipitated with diethyl ether.

In the second step, star-PEGs (dried under vacuum) was dissolved in 50 mL dry and distilled THF then combined with triethylamine and stirred under nitrogen. 7-Chlorocarbonylethoxycoumarin (product (4) in FIG. 11) was dissolved in 20 mL dry and distilled THF and added dropwise to the PEG and triethylamine mixture at 0° C. After 48 hours at 40° C., THF was evaporated and the product dissolved in a NaHCO₃ saturated solution. Finally, the mixture was dialysed to eliminate the excess of 7-Chlorocarbonylethoxycoumarin and lyophilized. The chemical structures and the molecular weights of the polymers were confirmed respectively by ¹H NMR (d-CDCl₃, 400 MHz) and chromatography (SEC with THF as solvent) analysis. The synthesized coumarin-based PEG with corresponding molecular weight and number of coumarin per chain are listed in Table 4.

TABLE 4

| | PEG, Mn (g/mol) | f | Coumarin groups |
|---|---|---|---|
| 1 | 1000 | 2 | chain-end |
| 2 | 2000 | 2 | chain-end |
| 3 | 5600 | 2 | chain-end |
| 4 | 3500 | 3 | chain-end (star-shaped) |
| 5 | 3000 | 4 | chain-end (star-shaped) |

f = functionality in coumarin

### Example 7

### Photoreversible Reaction of Coumarin-Functionalized Polyethylene Glycol

### 7a) Crosslinking Step

Linear difunctional coumarin-based PEG (2000 g/mol, product (10) in FIG. 13 and reference 2 in Table 4) was dissolved in an aqueous solution to form a liquid or viscous composition. The composition was then placed in a mold and irradiated at wavelength L1 (also referred to as λ₁)>300 nm (I=100 mW/cm²) for 10 minutes. This treatment fully converted the liquid into a transparent solid, reproducing quite precisely the shape of the mold.

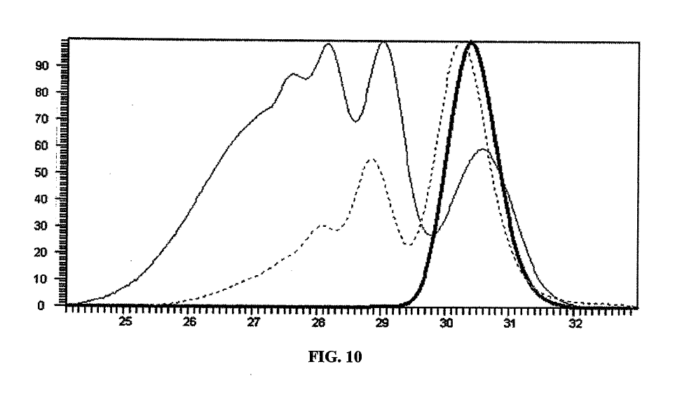

The mixture after irradiation was analyzed by size exclusion chromatography (SEC) (in THF) and the obtained curve was compared with the curve of the initial mixture, as shown in FIG. 10. Such comparison shows that new peaks appear for shorter times, which means products with higher molecular weight and a strong decrease of the peak area of the initial product. In the initial product, all the chains have the same length (2000 g/mol and peak centered on 30.4 minutes). Such a chain abbreviated as COU-PEG-COU is called a monomer unit. After irradiation, the coumarin dimerizes, forming dimer units. The dimer units have a doubled molecular weight compared to the COU-PEG-COU monomer unit (peak centered on 29 min). Trimer and tetramer units were also obtained as deduced from the SEC analysis. The respective concentrations of the monomer, dimer, trimer and tetramer units are measured from the peak area and are listed in Table 5. The increase of concentration in dimer, trimer and tetramer units and the decrease in monomer unit indicate successful photodimerization reaction through the coumarin photoactive groups.

Trifunctionalized and quadrifunctionalized coumarin-based PEG (products (13) and (14) in FIG. 14 and references 4 and 5 in Table 4) were also crosslinked by using the same procedure. The obtained products were not soluble in common solvents and hence could not be analyzed by SEC but their insolubility proves an efficient crosslinking reaction.

### 7b) Uncrosslinking Step

Crosslinked linear difunctional coumarin-based PEG (as obtained from example 7a) was irradiated during 24 h at wavelength L2 (also referred to as λ₂)=254 nm by using a sterilization UV lamp. After irradiation, the area of the peaks decreased, which indicates the decrease in both the molecular weight and the dimers, trimers, tetramers concentrations, as visible in FIG. 10. In addition, the peak, corresponding to the monomer unit, increased. The respective concentrations of the monomer, dimer, trimer and tetramer units after irradiation at λ₂=254 nm were measured from the peak area and were listed in Table 5. These results confirm the uncrosslinking of the polymer chains.

TABLE 5

| | monomer | dimer | trimer | tetramers, |
|---|---|---|---|---|
| | units | units | units | pentamers, . . . |
| t₀ | 100% | 0% | 0% | 0% |
| After irradiation at | 21% | 21% | 20% | 38% |
| λ > 300 nm | | | | |
| After irradiation at | 60% | 19% | 7% | 14% |
| λ = 254 nm | | | | |

1. An organic liquid composition that can reversibly and repeatedly crosslink to form a solid polymer network, the organic liquid composition comprising a mixture of a linear polymeric chain having two photoactive groups as endgroup; and a multifunctional polymeric chain having at least three photoactive groups, wherein said liquid composition can be crosslinked to from the solid polymer network by irradiation at a first wavelength L1 and at least partially-uncrosslinked to form a liquid by at least locally irradiating the network at a second wavelength L2 in order to repeatedly adjust shape and optical properties of said composition in its crosslinked state.

2. The liquid composition according to claim 1 wherein the composition is irradiated in situ in a receptacle or a mold.

3. The composition according to claim 2 wherein the receptacle has at least one flexible wall.

4. The composition according to claim 1, wherein the different wavelengths L1 and L2 are chosen in the spectrum of visible light, near infrared or near UV spectrum.

5. The composition according to claim 1, wherein the irradiation is a laser-assisted irradiation.

6. The composition according to claim 1, wherein the polymeric chains have a glass transition temperature lower than 40° C.

7. The composition according to claim 1, wherein the formed solid polymer network is transparent.

8. The composition according to claim 1, wherein the polymeric chains are polyethylene glycol, polypropylene glycols, poly(ethylene-co-propylene) glycols, polyacrylates, polydimethylsiloxanes or polysiloxanes.

9. The composition according to claim 1, wherein the multifunctional polymeric chains have a linear or star shaped structure.

10. The composition according to claim 1, wherein the photoactive groups per chain are selected from the group consisting of coumarin, thymine, anthracene, cinnamic acid groups and cinnamates.

11. The composition according to claim 9 wherein the photoactive group is coumarin.

12. A synthetic polymerized transparent optical element having a repeatedly and reversibly adjustable shape and/or optical properties comprising a composition according to claim 1.

13. The synthetic optical element according to claim 12 having the shape of an intraocular lens.

14. The synthetic optical element according to claim 12 having the shape of a prism.

15. The composition according to claim 1, wherein the multifunctional polymeric chain is either a star-shaped polymeric chain having at least three branches of equivalent length having a photoactive group at each end of each branch, or a polymer having at least three photoactive groups as pendant groups along a main chain.

16. The composition according to claim 1, wherein the ratio of difunctional linear polymeric chains and multifunctional polymeric chains may be ranged from 20%/80% to 50%/50%, where % represents the weight percentage.

17. The composition according to claim 8, wherein when the polymeric chains are polydimethylsiloxanes, the molecular weight for difunctional polymeric chain is in the range 1000-30000 g/mol.

18. A method for repeatedly and reversibly adjusting the shape of a photoactive network, the method comprising the steps of:
i) crosslinking of an organic liquid composition according to claim 1 by an irradiation with an electromagnetic wave at a specific wavelength L1 to obtain a crosslinked composition; and
ii) at least a partial uncrosslinking by irradiation at wavelength L2 of the crosslinked composition to obtained free liquid chains.

19. The composition of claim 1 is hydrophilic compositions that are (i) a mixture of linear and star chains of polyethylene glycols (PEG) end-capped with coumarin or (ii) a mixture of linear chains of poly(hydroxyethylmethacrylate) bearing pendant coumarin; or hydrophobic compositions that are (i) a mixture of linear and star chains of as poly(ethylacrylate) end-capped with coumarin or (ii) a mixture of poly(dimethylsiloxane) (PDMS) bearing pendant coumarins.

20. The method according to claim 18, further comprising the step of:
iii) osmotic diffusion of the free liquid chains to the still fully crosslinked regions, inducing a shape modification through swelling; and
iv) fixing of a modified shape by stopping the migration of the free liquid chains by irradiation at wavelength L1.
